(19) United States
(12) Patent Application Publication
(10) Pub. No.: US 2026/0253373 A1
(43) Pub. Date: Aug. 27, 2026

(54) INFORMATION PROCESSING DEVICE, INFERENCE MODEL GENERATION METHOD, AND NON-TRANSITORY COMPUTER-READABLE MEDIUM

(71) Applicant: NEC Corporation, Tokyo (JP)

(72) Inventors: Keisuke SUZUKI, Tokyo (JP); Mitsuru NOMA, Tokyo (JP); Osamu HISAMATSU, Tokyo (JP)

(73) Assignee: NEC Corporation, Tokyo (JP)

(21) Appl. No.: 19/535,004

(22) Filed: Feb. 10, 2026

(30) Foreign Application Priority Data
Feb. 25, 2025 (JP) 2025-028233

(51) Int. Cl. G06V 10/75; G06V 10/46

(52) U.S. Cl. CPC G06V 10/751; G06V 10/467

(57) ABSTRACT

An information processing device includes a waveform detection unit for detecting, from image data indicating a waveform of a biological signal, a pixel group relevant to a portion of the waveform, and a digitizing unit for generating numerical data representing a time-series change of the biological signal in a predetermined unit relevant to the biological signal based on a detection result of the waveform detection unit. The generated numerical data can also be used for decision making in treatment or diagnosis, for example.

### INCORPORATION BY REFERENCE

This application is based upon and claims the benefit of priority from Japanese patent application No. 2025-028233, filed on Feb. 25, 2025, the disclosure of which is incorporated herein in its entirety by reference.

### TECHNICAL FIELD

The present disclosure relates to an information processing device, an inference model generation method, a digitizing method, and a digitizing program.

### BACKGROUND ART

Various biological signal data are utilized in various applications.

For example, JP 2021-112479 A below discloses an electrocardiographic signal analysis device capable of identifying the risk of aortic valve stenosis from an electrocardiogram using deep learning.

### SUMMARY

In the electrocardiographic signal analysis device of JP 2021-112479 A, electrocardiogram data conforming to medical waveform form at encoding rules (MFER) is used. The MFER is a standard standardized so that all medical waveforms such as an electroencephalogram and a respiratory waveform can be described, including electrocardiograms. One of the characteristics of the medical waveform in the MFER format is that conversion between numerical values and images is possible.

However, there are many medical waveforms of various biological signals including an electrocardiogram to which a special format such as the MFER format is not applied, and a person has to visually read numerical values of such image data. This is a big obstacle, for example, in a case where numerical data of a biological signal is used for deep learning.

The present disclosure has been made in view of the above problems, and an example object thereof is to provide a technique capable of automatically generating numerical data representing a time-series change of a biological signal even if image data representing a waveform of the biological signal is not obtained by applying a special format.

An information processing device according to an example aspect of the present disclosure includes a waveform detection means for detecting, from image data indicating a waveform of a biological signal, a pixel group relevant to a portion of the waveform, and a digitizing means for generating numerical data representing a time-series change of the biological signal in a predetermined unit relevant to the biological signal based on a detection result of the waveform detection means.

A digitizing method according to an example aspect of the present disclosure causes at least one processor to execute waveform detection processing of detecting, from image data indicating a waveform of a biological signal, a pixel group relevant to a portion of the waveform, and digitizing processing of generating numerical data representing a time-series change of the biological signal in a predetermined unit relevant to the biological signal based on a detection result of the waveform detection processing.

A digitizing program according to an example aspect of the present disclosure causes a computer to function as a waveform detection means for detecting a pixel group relevant to a portion of a waveform from image data indicating the waveform of the biological signal, and a digitizing means for generating numerical data representing a time-series change of the biological signal in a predetermined unit relevant to the biological signal based on a detection result of the waveform detection means.

According to an example aspect of the present disclosure, it is possible to provide a technique capable of automatically generating numerical data representing a time-series change of a biological signal even in a case where image data indicating a waveform of the biological signal is not data to which a special format is applied.

### BRIEF DESCRIPTION OF THE DRAWINGS

FIG. 1 is a block diagram illustrating a configuration of an information processing device according to the present disclosure;

FIG. 2 is a flowchart illustrating a flow of a digitizing method according to the present disclosure;

FIG. 3 is a block diagram illustrating a configuration of another information processing device according to the present disclosure;

FIG. 4 is a diagram illustrating an example of image data acquired by a data acquisition unit;

FIG. 5 is a diagram illustrating image data generated by performing binarization processing on a second area of the image data illustrated in FIG. 4;

FIG. 6 is a diagram illustrating an example of an electrocardiogram waveform to be digitized;

FIG. 7 is a flowchart illustrating an example of processing executed by the information processing device illustrated in FIG. 3; and

FIG. 8 is a block diagram illustrating a configuration of a computer that functions as an information processing device according to the present disclosure.

### EXAMPLE EMBODIMENT

Hereinafter, example embodiments of the present invention will be described. However, the present invention is not limited to the following illustrative example embodiments, and various modifications can be made within a scope described in the claims. For example, example embodiments obtained by appropriately combining techniques (some or all of things or methods) adopted in the following illustrative example embodiments can also be included in the scope of the present invention. Example embodiments obtained by appropriately omitting some of the techniques adopted in the following illustrative example embodiments can also be included in the scope of the present invention. Effects mentioned in the following illustrative example embodiments are examples of effects expected in the illustrative example embodiments, and do not define extension of the present invention. That is, illustrative example embodiments that do not achieve the effects mentioned in each of the illustrative example embodiments described below can also be included in the scope of the present invention.

### First Illustrative Example Embodiment

A first illustrative example embodiment that is an example of the example embodiments of the present invention will be described in detail with reference to the drawings. The present illustrative example embodiment is a basic form of each illustrative example embodiment to be described below. An application range of each technique adopted in the present illustrative example embodiment is not limited to the present illustrative example embodiment. That is, each technique adopted in the present illustrative example embodiment can also be adopted in another illustrative example embodiment included in the present disclosure within a range in which no particular technical problem occurs. Each technology illustrated in the drawings referred to for describing the present illustrative example embodiment can also be adopted in other illustrative example embodiments included in the present disclosure within a range in which no particular technical problem occurs.

### (Configuration of Information Processing Device 1)

A configuration of an information processing device 1 according to the present illustrative example embodiment will be described with reference to FIG. 1. FIG. 1 is a block diagram illustrating the configuration of the information processing device 1. As illustrated in FIG. 1, the information processing device 1 includes a waveform detection unit 101 and a digitizing unit 102.

The waveform detection unit 101 detects a pixel group relevant to a portion of the waveform from the image data indicating the waveform of the biological signal. Here, the “biological signal” is a signal derived from a living body and reflecting a state or a function of the living body or an organ thereof. For example, signals such as an electrocardiogram, an electroencephalogram, a magnetoencephalogram, a heart rate, a body temperature, and a blood pressure can be used as the biological signal. The time-series biological signal can be expressed as a waveform, and the “image data” is data indicating such a waveform. Then, in the image data indicating the waveform, since the portion of the waveform and the portion of the background can be identified, the waveform detection unit 101 can detect a pixel group relevant to the portion of the waveform from the image data. The image data may be any data that can detect a pixel group relevant to a portion of a waveform from the image data, and does not need to be image data in a special format.

The digitizing unit 102 generates numerical data representing the time-series change of the biological signal in a predetermined unit relevant to the biological signal based on the detection result of the waveform detection unit 101. Here, the “predetermined unit according to the biological signal” may be any appropriate unit for representing the biological signal. For example, in a case where the biological signal is an electrocardiogram, a unit indicating a potential (typically mV: millivolt) may be set as a predetermined unit. For example, in a case where the biological signal is a heart rate, a unit (typically, times/minute) indicating the heart rate per unit time may be set as a predetermined unit. Here, “numerical data” means data including numerical values as elements.

Generating numerical data based on the detection result of the waveform detection unit 101 means generating numerical data by directly or indirectly using the detection result of the waveform detection unit 101. For example, the digitizing unit 102 may generate the numerical data using data obtained by analyzing the detection result of the waveform detection unit 101.

As described above, the information processing device 1 according to the present illustrative example embodiment employs a configuration including the waveform detection unit 101 that detects the pixel group relevant to the portion of the waveform from the image data indicating the waveform of the biological signal, and the digitizing unit 102 that generates numerical data representing the time-series change of the biological signal in a predetermined unit relevant to the biological signal based on the detection result of the waveform detection unit 101.

According to the above configuration, even if the image data indicating the waveform of the biological signal does not apply a special format, it is possible to automatically generate numerical data indicating the time-series change of the biological signal.

### (Digitizing Program)

The functions of the information processing device 1 described above can also be achieved by a program. A digitizing program according to the present illustrative example embodiment causes a computer to function as a waveform detection means for detecting a pixel group relevant to a portion of a waveform from image data indicating the waveform of the biological signal, and a digitizing means for generating numerical data representing a time-series change of the biological signal in a predetermined unit relevant to the biological signal based on a detection result of the waveform detection means. According to this digitizing program, it is possible to automatically generate numerical data representing a time-series change of a biological signal even if image data representing a waveform of the biological signal is not image data to which a special format is applied.

### (Flow of Digitizing Method)

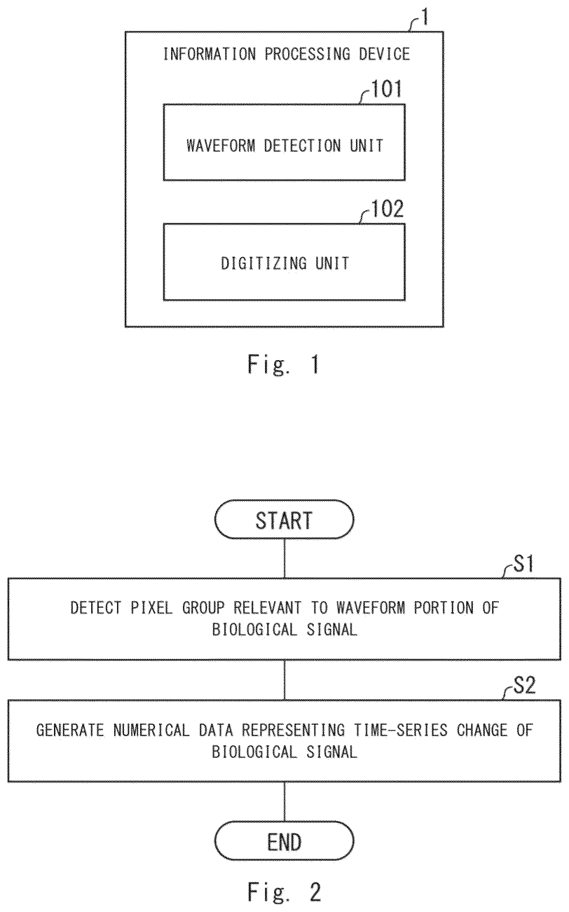

A flow of a digitizing method according to the present illustrative example embodiment will be described with reference to FIG. 2. FIG. 2 is a flowchart illustrating the flow of the digitizing method. An executing entity of each step in this digitizing method may be a processor included in the information processing device 1, may be a processor included in another device, or an executing entity of each step may be a processor provided in each of different devices.

In S1 (waveform detection processing), at least one processor detects a pixel group relevant to a portion of a waveform from image data indicating the waveform of the biological signal.

In S2 (digitizing processing), the at least one processor generates numerical data representing a time-series change of the biological signal in a predetermined unit relevant to the biological signal based on the detection result in S1.

As described above, in the digitizing method according to the present illustrative example embodiment, a configuration is adopted in which the at least one processor executes waveform detection processing of detecting a pixel group relevant to a portion of a waveform from image data indicating a waveform of a biological signal, and digitizing processing of generating numerical data representing a time-series change of the biological signal in a predetermined unit relevant to the biological signal based on a detection result in the waveform detection processing. According to this digitizing method, even if the image data indicating the waveform of the biological signal is not obtained by applying a special format, it is possible to automatically generate numerical data indicating the time-series change of the biological signal.

### Second Illustrative Example Embodiment

A second illustrative example embodiment that is an example of the example embodiments of the present invention will be described in detail with reference to the drawings. Components having the same functions as the components described in the above-described illustrative example embodiment are denoted by the same reference signs, and the description thereof will be appropriately omitted. An application range of each technique adopted in the present illustrative example embodiment is not limited to the present illustrative example embodiment. That is, each technique adopted in the present illustrative example embodiment can also be adopted in another illustrative example embodiment included in the present disclosure within a range in which no particular technical problem occurs. Each technique illustrated in each of the drawings referred to for describing the present illustrative example embodiment can be employed in the other illustrative example embodiments included in the present disclosure within the scope in which no particular technical problem occurs.

### (Configuration of Information Processing Device 1A)

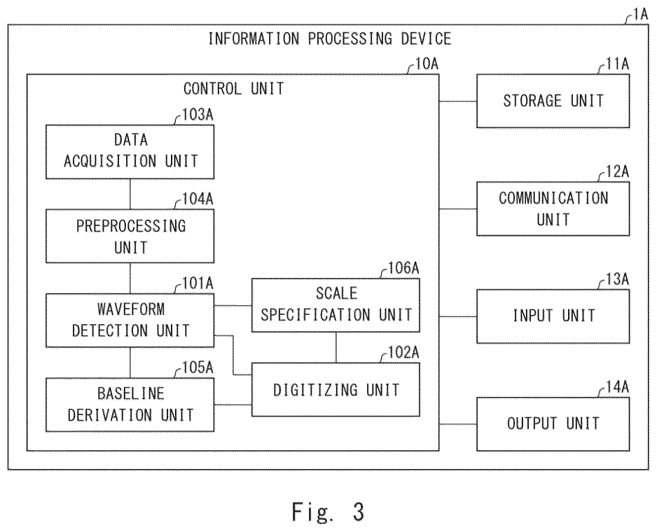

A configuration of an information processing device 1A according to the present illustrative example embodiment will be described with reference to FIG. 3. FIG. 3 is a block diagram illustrating a configuration of the information processing device 1A. The information processing device 1A is a device having a function of generating numerical data from image data of a biological signal.

As illustrated, the information processing device 1A includes a control unit 10A for integrally controlling each unit of the information processing device 1A, and a storage unit 11A for storing various types of data to be used by the information processing device 1A. The information processing device 1A includes a communication unit 12A for the information processing device 1A to communicate with another device, an input unit 13A for accepting an input to the information processing device 1A, and an output unit 14A for the information processing device 1A to output data. The control unit 10A includes a waveform detection unit 101A, a digitizing unit 102A, a data acquisition unit 103A, a preprocessing unit 104A, a baseline derivation unit 105A, and a scale specification unit 106A.

Similarly to the waveform detection unit 101 of the first illustrative example embodiment, the waveform detection unit 101A detects a pixel group relevant to a portion of a waveform from image data indicating a waveform of a biological signal. Image data of any biological signal is to be subjected to waveform detection. Hereinafter, an example in which image data of an electrocardiogram is a waveform to be detected will be mainly described, but the “electrocardiogram” in the following description can be basically replaced with any “biological signal”.

Similarly to the digitizing unit 102 of the first illustrative example embodiment, the digitizing unit 102A generates numerical data representing the time-series change of the biological signal in a predetermined unit relevant to the biological signal based on the detection result of the waveform detection unit 101A. For example, in a case where the biological signal is an electrocardiogram, the digitizing unit 102A generates numerical data representing the time-series change of cardiac potential in units of millivolts (mV).

The data acquisition unit 103A acquires image data indicating a waveform to be detected by the waveform detection unit 101A. Although details will be described below, the waveform detection unit 101A detects a pixel group relevant to a portion of the waveform from image data obtained by performing preprocessing of removing elements other than the waveform by the preprocessing unit 104A on the image data (hereinafter, referred to as original image data) acquired by the data acquisition unit 103A.

The preprocessing unit 104A performs preprocessing of removing elements other than the waveform on the original image data acquired by the data acquisition unit 103A, and generates image data to be a target for the waveform detection unit 101A to detect a pixel group. Details of the preprocessing executed by the preprocessing unit 104A will be described later.

The baseline derivation unit 105A derives a baseline serving as a reference for generating numerical data representing a time-series change of the biological signal in a predetermined unit relevant to the biological signal. For example, in a case where the biological signal is an electrocardiogram, the baseline derivation unit 105A may detect a portion where the cardiac potential becomes linear in the waveform of the electrocardiogram, and derive the baseline based on the potential of the linear portion. For example, the baseline derivation unit 105A may detect a plurality of points at which the cardiac potential becomes 0 in the waveform of the electrocardiogram, and derive a straight line passing through each detected point as a baseline.

The scale specification unit 106A specifies a scale in the image data indicating the waveform of the biological signal. The digitizing unit 102A generates numerical data using the specified scale. A method of specifying a scale and a method of generating numerical data using the specified scale will be described later.

As described above, similarly to the information processing device 1, the information processing device 1A according to the present illustrative example embodiment employs a configuration including the waveform detection unit 101A that detects the pixel group relevant to the portion of the waveform from the image data indicating the waveform of the biological signal, and the digitizing unit 102 that generates numerical data representing the time-series change of the biological signal in a predetermined unit relevant to the biological signal based on the detection result of the waveform detection unit 101A. Therefore, even in the information processing device 1A, even if the image data indicating the waveform of the biological signal does not apply a special format, it is possible to automatically generate numerical data indicating the time-series change of the biological signal.

### (Preprocessing Example 1: Extraction of Part of Original Image Data)

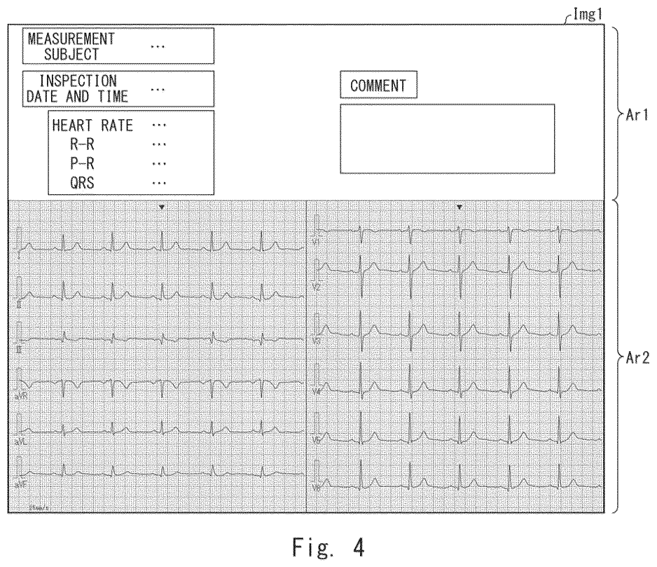

An example of preprocessing by the preprocessing unit 104A will be described with reference to FIG. 4. FIG. 4 is a diagram illustrating an example of image data (that is, the above-described original image data) acquired by the data acquisition unit 103A. Original image data Img1 illustrated in FIG. 4 is image data of an electrocardiogram. More specifically, the original image data Img1 is image data of a 12-lead electrocardiogram, and includes 12 waveforms relevant to 12 types of leads.

As illustrated in the drawing, the image area of the original image data Img1 is divided into a first area Ar1 in which electrocardiogram related information such as the name of the subject to be measured in the electrocardiogram, the measurement date and time, the analysis result, and the comment of the laboratory technician is displayed, and a second area Ar2 in which the electrocardiogram waveforms of 12 leads are displayed.

In a case where such original image data Img1 is acquired, the preprocessing unit 104A may extract the second area Ar2 from the original image data Img1. For example, in a case where the ranges occupied by the first and second areas are determined in the original image data Img1, the preprocessing unit 104A may extract the range of the second area Ar2 from the original image data Img1. For example, the preprocessing unit 104A may analyze the original image data Img1 to specify the range of the second area Ar2, and extract the specified range from the original image data Img1. The extraction range may be designated by the user. In this case, the preprocessing unit 104A may extract the range designated by the user from the original image data Img1 via the communication unit 12A or the input unit 13A.

As described above, the preprocessing unit 104A may perform processing of extracting an area where a waveform is drawn in the original image data as preprocessing of removing elements other than the waveform from the original image data. As a result, it is possible to eliminate the influence of the area where the waveform is not drawn in the original image data and to facilitate or improve the accuracy of the waveform detection by the waveform detection unit 101A.

### (Preprocessing Example 2: Removal of Grid Line of Background of Waveform)

Here, in the original image data Img1 illustrated in FIG. 4, a lattice-like grid line indicating the scale of the waveform is drawn on the background of the electrocardiogram waveform. Such grid lines can also interfere with the detection of the waveform by the waveform detection unit 101A. Therefore, the preprocessing unit 104A may perform preprocessing of removing the background grid line of the electrocardiogram waveform.

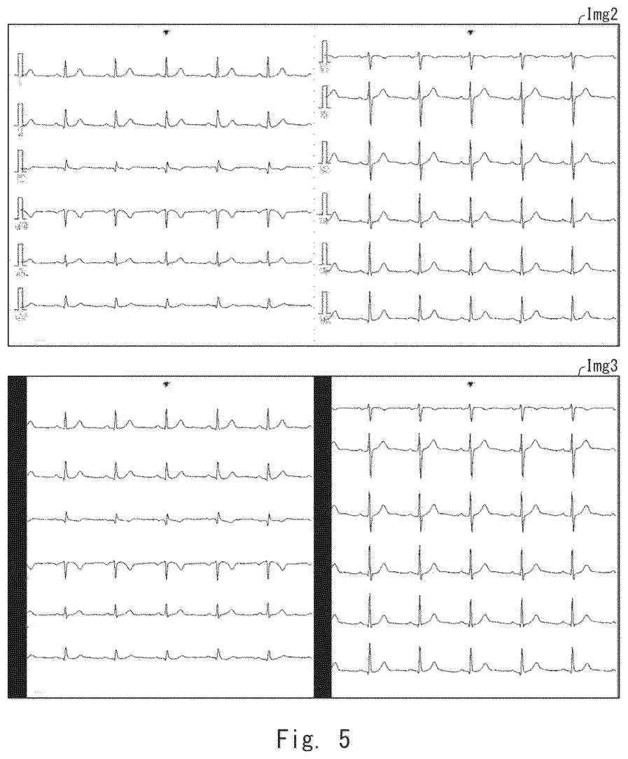

For example, the preprocessing unit 104A may remove the grid line of the background of the electrocardiogram waveform by binarizing the original image data. FIG. 5 is a diagram illustrating image data Img2 generated by performing the binarization processing on the second area Ar2 in the original image data Img1 illustrated in FIG. 4. By appropriately setting the binarization threshold, the image data Img2 from which the grid line drawn on the background of the electrocardiogram waveform is removed is obtained.

The image data Img2 includes, in addition to the electrocardiogram waveforms of 12 leads, symbols such as “I” and “II” indicating the type of each lead, and waveforms called rectangular waves or calibration waves. The preprocessing unit 104A may remove such an area where information other than the waveform is displayed.

For example, the preprocessing unit 104A may perform mask processing on an area where information other than the waveform is displayed. Image data Img3 illustrated in FIG. 5 is an example of image data generated by performing mask processing on an area where information other than a waveform is displayed in the image data Img2. Since what area the information other than the waveform is displayed is usually determined, the preprocessing unit 104A may set the area where such information is displayed as a target of the mask processing.

The preprocessing unit 104A may detect characters and the like other than the waveform by processing such as optical character recognition (OCR) and remove the detected characters and the like. The preprocessing unit 104A may detect and remove a figure other than the waveform by pattern matching or the like. In a case where the display color is different between the waveform and the portion other than the waveform, the preprocessing unit 104A may detect and remove the portion other than the waveform based on the color.

In the image data Img3 of FIG. 5, the area subjected to the mask processing is illustrated in black, but the mask processing may be processing of setting each pixel included in the target area to white (pixel value of zero).

Instead of performing the mask processing, the area to be detected by the waveform detection unit 101A may be narrowed down to an area where information such as symbols other than the waveform is not displayed. In a case where a plurality of waveforms are included in the original image data, the preprocessing unit 104A may perform preprocessing of cutting out each area where each waveform appears.

As described above, the information processing device 1A includes the preprocessing unit 104A that performs preprocessing of removing elements other than a waveform on original image data that is a source of image data to generate image data for the waveform detection unit 101A to detect a waveform. As a result, in addition to the effect obtained by the information processing device 1, it is possible to eliminate the influence of elements other than the waveform in the original image data and to facilitate or improve the accuracy of the detection of the waveform by the waveform detection unit 101A.

### (Detection of Pixel Group Relevant to Waveform Portion)

The waveform detection unit 101A detects a pixel group relevant to a portion of the waveform of the electrocardiogram from the image data generated by the preprocessing unit 104A as described above. In the detection of the pixel group, the waveform detection unit 101A assigns a coordinate value to each pixel included in the image data. For example, the waveform detection unit 101A may assign a coordinate value to each pixel of the image data, assuming that the coordinates of the pixel at the reference position such as the upper left end of the image data are (0,0), the right direction of the image data is the positive direction of the x axis, the downward direction is the positive direction of the y axis, and the interval between adjacent pixels is 1. As a result, the pixels included in the image data can be represented by coordinate values relevant to the positions, and the pixels relevant to the portions of the waveform can be detected using the coordinate values.

A method of detecting the pixel relevant to the portion of the waveform is not particularly limited. For example, the waveform detection unit 101A may detect a pixel group including adjacent pixels in the image data as a pixel group relevant to a portion of the waveform of the electrocardiogram. As in the image data Img3 of FIG. 5, in a case where the target is the image data generated by the preprocessing that excludes all the elements other than the waveform, it is possible to detect the pixel group relevant to the portion of the waveform of the electrocardiogram by such simple processing. From the image data Img3, 12 pixel groups relevant to the 12 types of lead are detected.

The waveform detection unit 101A can also detect a pixel group relevant to a portion of a waveform from image data including elements other than the waveform, like the image data Img2 of FIG. 5. In this case, the waveform detection unit 101A may detect, as the pixel group relevant to the waveform portion of the electrocardiogram, a pixel group that satisfies a condition specific to the pixel group relevant to the waveform portion among the pixel groups including the adjacent pixels in the image data. For example, the waveform detection unit 101A may set a pixel group having the number of elements equal to or larger than a threshold as a pixel group relevant to a portion of the waveform of the electrocardiogram. For example, the waveform detection unit 101A may set a pixel group in which the distance from the left end pixel to the right end pixel is equal to or more than a threshold as a pixel group relevant to a portion of the waveform of the electrocardiogram. By these processes, a pixel group relevant to an element such as a character or a symbol can be excluded.

Here, in the image data Img2 of FIG. 5, a rectangular waveform is drawn at the left end of the twelve electrocardiogram waveforms. This waveform is called a rectangular wave or a calibration wave as described above, and is an object for calibration. In the image data Img2, since the electrocardiogram waveform intersects the calibration wave, in a case where a pixel group is detected from the image data Img2 under the condition of “a pixel group including adjacent pixels”, a pixel group including pixels including the electrocardiogram waveform and pixels including the calibration wave is detected.

Therefore, the waveform detection unit 101A may distinguish and detect the electrocardiogram waveform and the calibration wave. Since the shapes of the electrocardiogram waveform and the calibration wave are clearly different from each other, it is possible to distinguish and detect the electrocardiogram waveform and the calibration wave based on the difference in shape. For example, the waveform detection unit 101A may detect a pixel group including a calibration wave from image data by pattern matching or the like. In this case, the waveform detection unit 101A removes each pixel of the pixel group including the calibration wave from the pixel group including the pixels including the electrocardiogram waveform and the pixels including the calibration wave, and detects the rest pixels as the pixel group relevant to the waveform portion of the electrocardiogram.

It is not always necessary to cause the waveform detection unit 101A to detect the pixel group including the calibration wave. A detection unit that detects a pixel group including the calibration wave may be provided separately from the waveform detection unit 101A.

### (Method of Generating Numerical Data)

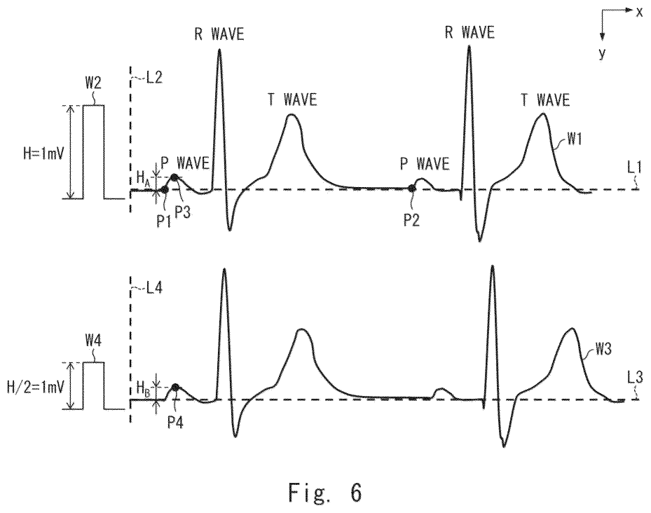

A method of generating numerical data by the digitizing unit 102A will be described with reference to FIG. 6. FIG. 6 is a diagram illustrating an example of an electrocardiogram waveform to be digitized. In a waveform W1 illustrated in FIG. 6, waveforms called a P wave, an R wave, and a T wave are periodically repeated. A calibration wave W2 is drawn in association with the waveform W1. As illustrated in the drawing, the calibration wave W2 is drawn in such a size that the height H becomes 1 mV.

In generating the numerical data, the baseline derivation unit 105A derives the baseline, and the scale specification unit 106A specifies the scale.

Hereinafter, a method of deriving the baseline and a method of specifying the scale will be sequentially described.

### (Method of Deriving Baseline)

The baseline in the electrocardiogram is a linear portion in the electrocardiogram, and represents a state in which there is no electrical activity in the myocardium. For example, the baseline derivation unit 105A may detect each pixel located at the starting point of the P wave among the pixels included in the pixel group detected by the waveform detection unit 101A, calculate an average value of the y coordinates of these pixels, and derive a straight line represented by an expression of y=μ as a baseline. The pixel located at the starting point of the P wave can be detected by analyzing the coordinate value of each pixel included in the pixel group detected by the waveform detection unit 101A.

For example, the baseline derivation unit 105A may detect a pixel located at the start point of the P wave and a pixel located at the start point of the next P wave, and derive a straight line passing through these points as a baseline. In this case, the baseline derivation unit 105A may detect, from the pixel group detected by the waveform detection unit 101A, the coordinate value of the pixel located at the starting point of the P wave and the coordinate value of the pixel located at the starting point of the next P wave, and derive, as the baseline, an expression of a straight line connecting the detected coordinate values. For example, in the example of FIG. 6, the baseline derivation unit 105A detects the coordinate value of a starting point P1 of the first P wave included in the waveform W1 and the coordinate value of a starting point P2 of the second P wave, thereby deriving a straight line connecting these two points as the baseline L1.

For example, the baseline derivation unit 105A may detect a section in which numerical data is constant or substantially constant, calculate an average value of the y coordinate in the detected section, and derive a straight line represented by an expression of y=μ as a baseline. Since the value of the y-coordinate on the baseline of the waveform is constant or substantially constant, it is also possible to derive the baseline by such a method. For example, the baseline derivation unit 105A may calculate the values of the following mathematical expression for each of i=0, 1, . . . , and N using the minute bandwidth h and assuming the value of the y coordinate of the numerical data as yᵢ.

$${\sum }_{k = 1}^{i + h} \vert {y}_{k} - {y}_{k + 1} \vert \qquad [ Math 1 ]$$

Since the value of the above expression indicates the magnitude of variation of the numerical data near yᵢ, the baseline derivation unit 105A may detect a section in which the calculated value is small as a section in which the numerical data is constant or substantially constant. Then, the baseline derivation unit 105A may calculate the average value of the μ coordinate in the detected section and derive a straight line represented by an expression of y=μ as a baseline.

### (Method of Specifying Scale)

The vertical direction (y-axis direction) in the waveform of the electrocardiogram indicates the strength of the potential (which can also be referred to as amplitude), and the potential of 1 mV is usually represented by 10 mm, but depending on the amplitude of the waveform, the potential of 1 mV may be represented by 5 mm, the potential of 1 mV may be represented by 2.5 mm, and the potential of 1 mV may be represented by 20 mm. Assuming that the scale in a case where the potential of 1 mV is represented by 10 mm is 1 time, the scale in a case where the potential of 1 mV is represented by 5 mm is 1/2 times, the scale in a case where the potential of 1 mV is represented by 2.5 mm is 1/4 times, and the scale in a case where the potential of 1 mV is represented by 20 mm is 2 times. By considering such a scale, the coordinates of each pixel relevant to the portion of the waveform detected by the waveform detection unit 101A can be converted into appropriate numerical data.

To specify the scale, a reference object drawn such that a predetermined numerical value represented in a predetermined unit has a predetermined size is used. As described above, a waveform called a calibration wave is drawn on the electrocardiogram. The scale can be specified by using the calibration wave as the reference object.

For example, in the example of FIG. 6, the calibration wave W2 is drawn in association with the waveform W1, while a calibration wave W4 is drawn in association with a waveform W3. The height of the calibration wave W2 is H, whereas the height of the calibration wave W4 is H/2. All of these calibration waves indicate 1 mV. That is, the waveform W1 associated with the calibration wave W2 is displayed at a scale where 1 mV is H. On the other hand, the waveform W3 associated with the calibration wave W4 is displayed at a scale where 1 mV is H/2. That is, the waveform W3 is displayed at a scale 1/2 times the waveform W1 in the y-axis direction.

In a case where the calibration wave is used as the reference object, the scale specification unit 106A specifies the height of the calibration wave in the image data. For example, the scale specification unit 106A may specify a maximum value and a minimum value from among the values of the y coordinate of each pixel including the calibration wave, and may specify a value obtained by subtracting the specified minimum value from the specified maximum value as the height of the calibration wave. Then, the scale specification unit 106A specifies how many mV a waveform is drawn per unit height (one pixel) by dividing 1 mV by the specified height. For example, since the height of the calibration wave W2 drawn in association with the waveform W1 of FIG. 6 is H, the calibration wave W2 is specified to be drawn at a scale of “1/H” mV per unit height in the y-axis direction. On the other hand, the calibration wave W4 is specified to be drawn to a scale of “2/H” mV per unit height in the y-axis direction.

The scale in the y-axis direction can also be obtained from the distance between predetermined two points on the waveform. Here, the predetermined two points are points at which the potential difference between the two points is known. For example, in the example of FIG. 6, in a case where the peak value of the P wave is known, the scale in the y-axis direction can be specified using the height of the P wave and the known peak value.

### (Generation of Numerical Data Using Baseline and Scale)

The digitizing unit 102A calculates numerical data of the pixel by multiplying the distance in the y direction between the pixel including the waveform and the baseline derived by the baseline derivation unit 105A by the scale specified by the scale specification unit 106A. Since the baseline is usually parallel to the x axis, the distance in the y direction from the baseline can be calculated by a difference between the value of the y coordinate initially allocated to each pixel and the value of the y coordinate of the baseline. Therefore, in a case where the coordinates of the pixel including the waveform are (x1, y1), the value of the y-intercept of the baseline is y2, and the scale is s, numerical data relevant to the y-coordinate of this pixel is expressed as (y1-y2)×s. As described above, the process of generating numerical data can also be said to be a process of converting the coordinate values initially allocated to each pixel based on the baseline and the scale.

For example, the distance from the pixel located at a vertex P3 of the first peak in the waveform W1 of FIG. 6 to the baseline L1 is H_{A} (the difference between the value of the y coordinate of the vertex P3 and the value of the y-intercept of the baseline L1). As described above, the scale of the waveform W1 is specified as 1/H. Therefore, the numerical data relevant to the y coordinate of the pixel located at the vertex P3 is calculated as (1/H)×H_{A}=(H_{A}/H) mV. This value indicates the peak value of the first P wave in the waveform W1. On the other hand, the distance from the pixel located at a vertex P4 of the first peak in the waveform W3 to the baseline L3 is H_{B}. Therefore, the numerical data relevant to the y coordinate of the pixel located at the vertex P4 is calculated as (2/H)×H_{B}=(2H_{B}/H) mV. This value indicates the peak value of the first P wave in the waveform W3.

### (About Value of x Coordinate)

The digitizing unit 102A can similarly convert the value of the x coordinate of the pixel including the waveform into numerical data. The x-axis direction in the waveform of the electrocardiogram indicates time, and its unit is usually seconds. Therefore, the digitizing unit 102A converts the value of the x coordinate of the pixel including the waveform into numerical data in units of “seconds”. For conversion of the value of the x coordinate, a baseline perpendicular to the x axis and a scale in the x-axis direction are used.

For example, the baseline derivation unit 105A may derive, as the baseline, a straight line perpendicular to the x axis passing through the pixel having the smallest value of the x coordinate among the pixels included in the pixel group detected by the waveform detection unit 101A. A baseline L2 in the waveform W1 and a baseline L4 in the waveform W3 in FIG. 6 can be derived in this manner. The position of the baseline may be designated by the user. In this case, the baseline derivation unit 105A may derive, as a baseline, a straight line that passes through a position designated by the user and is perpendicular to the x axis.

The scale in the x-axis direction can be specified using a reference object drawn such that a predetermined numerical value represented in a predetermined unit has a predetermined size in the x-axis direction. For example, in a case where a grid drawn on the background of the waveform is detected as a reference object, the scale specification unit 106A can specify the scale in the x-axis direction from the detected width of the grid. For example, in a case where the width of one grid relevant to 0.04 seconds is w, the scale in the x-axis direction is specified as (0.04/w). The detection of the grid may be performed by the waveform detection unit 101A, or a detection unit for detecting the grid may be provided separately from the waveform detection unit 101A.

The scale in the x-axis direction can also be obtained from the distance between predetermined two points on the waveform. Here, the predetermined two points are points at which the time interval between the two points is known. For example, in the example of FIG. 6, the time from the point P1 to the point P2 is referred to as P-P time. If the P-P time is known, the scale in the x-axis direction can be specified using the distance between the point P1 and the point P2 in the x-axis direction and the P-P time.

As described above, the information processing device 1A may include a detection unit that detects, from the image data, a reference object drawn such that a predetermined numerical value represented in a predetermined unit has a predetermined size. Then, based on the size of the detected reference object (more precisely, the width or height on the image data), the digitizing unit 102A may generate numerical data representing the time-series change of the biological signal in a predetermined unit. As a result, in addition to the effect obtained by the information processing device 1, it is possible to automatically generate numerical data having appropriate values for waveforms of various scales. As described above, the waveform detection unit 101A may be caused to detect the reference object, or a detection unit that detects the reference object may be provided separately from the waveform detection unit 101A.

As described above, the information processing device 1A may include the baseline derivation unit 105A that derives a baseline passing through a plurality of points at which the biological signal has a predetermined reference value in the waveform. Then, the digitizing unit 102A may generate numerical data representing the time-series change of the biological signal in a predetermined unit based on the distance from the pixel detected by the waveform detection unit 101A to the baseline. As a result, in addition to the effect obtained by the information processing device 1, it is possible to automatically generate numerical data of an appropriate value based on the baseline.

The detection of the baseline and the specification of the scale are not necessarily performed automatically. In other words, it is not essential to provide the baseline derivation unit 105A, and it is not essential to provide the scale specification unit 106A. For example, either or both of the baseline and the scale may be designated by the user. In this case, the digitizing unit 102A may generate numerical data by applying a designated baseline and/or scale.

### (Modified Example of Method of Generating Numerical Data)

As described above, it is possible to generate numerical data by assigning a coordinate value to each pixel of the image data and then converting the coordinate value of each pixel of the pixel group relevant to the portion of the waveform. It is also possible to generate numerical data representing the time-series change of the biological signal in a predetermined unit relevant to the biological signal without performing such conversion.

For example, the digitizing unit 102A can also generate numerical data by setting, as a reference, a pixel whose value of a predetermined unit relevant to the biological signal is known among pixels included in the pixel group relevant to the waveform portion of the biological signal, and allocating a numerical value relevant to a positional relationship with the reference pixel to each pixel.

For example, it is assumed that coordinates of a left end point in the waveform W1 of FIG. 6 are (0 (seconds), 0 mV), one pixel in the x-axis direction is t (seconds), and one pixel in the y-direction is v (mV). These pieces of information may be input by the user or may be specified by analyzing image data.

In this case, the digitizing unit 102A may assign a numerical value relevant to the positional relationship with the reference point to another pixel included in the pixel group relevant to the waveform portion of the biological signal using the coordinates of the left end point in the waveform W1 as the reference point. Specifically, the digitizing unit 102A may allocate the numerical value of the x coordinate so as to increase by t every time one pixel is away from the reference point in the x-axis direction, and allocate the numerical value of the y coordinate so as to increase by v every time one pixel is away from the reference point in the y-axis direction. For example, the digitizing unit 102A may assign a numerical value (10t, 0) to a point 10 pixels away from the reference point in the x-axis direction. By allocating a numerical value to each point on the waveform W1 in this manner, the digitizing unit 102A can generate numerical data without performing conversion as described above.

### (Flow of Processing)

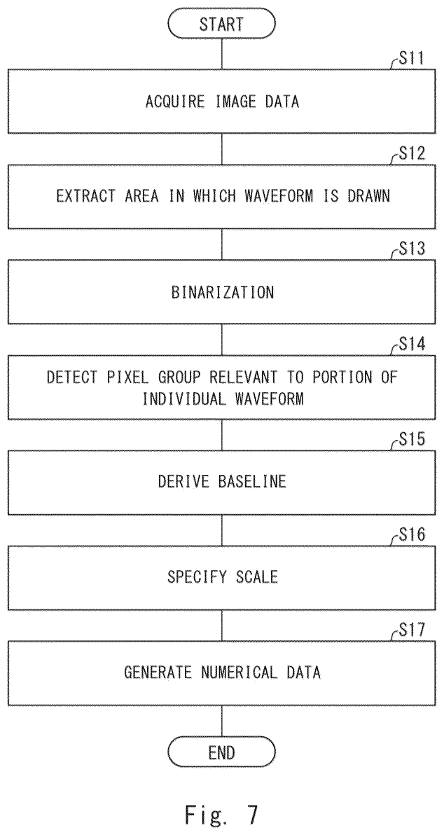

A flow of processing executed by the information processing device 1A will be described with reference to FIG. 7. FIG. 7 is a flowchart illustrating an example of the processing performed by the information processing device 1A. The flowchart of FIG. 7 includes each processing of the digitizing method according to the present illustrative example embodiment.

In S11, the data acquisition unit 103A acquires image data indicating a waveform to be detected by the waveform detection unit 101A. The image data acquired here is before preprocessing by the preprocessing unit 104A is performed, and is relevant to the above-described “original image data”. For example, the data acquisition unit 103A may acquire original image data including a display area of an element other than a waveform, such as the original image data Img1 of FIG. 4. The data acquisition unit 103A may acquire image data subjected to preprocessing by the information processing device 1A or another device, and in this case, the processing of S12 and S13 is omitted.

In S12, the preprocessing unit 104A extracts an area where a waveform to be digitized is drawn from the image data (original image data) acquired in S11. For example, in a case where the image data acquired in S11 is the original image data Img1 illustrated in FIG. 4, the preprocessing unit 104A extracts the second area Ar2 from the original image data Img1.

In S13, the preprocessing unit 104A binarizes the area extracted in S12 in the original image data. As a result, image data from which elements such as grid lines have been removed and which is to be detected by the waveform detection unit 101A is generated. For example, the preprocessing unit 104A may generate image data such as the image data Img2 of FIG. 5. For example, the preprocessing unit 104A may perform masking processing on an area where characters, symbols, and the like are drawn in the image data Img2 to generate the image data such as the image data Img3 of FIG. 5. The present illustrative example embodiment illustrates an example in which one preprocessing unit 104A performs a plurality of types of preprocessing, but a preprocessing unit may be provided for each type of preprocessing.

In S14 (waveform detection processing), the waveform detection unit 101A assigns coordinate values to each pixel included in the image data generated in S13, and then detects a pixel group relevant to the waveform portion of the biological signal from the image data. Since coordinate values are allocated to each pixel, it can be said that a coordinate value group indicating the waveform of the biological signal is detected in S14.

In a case where the image data generated in S13 includes a plurality of waveforms such as the image data Img2 and Img3 in FIG. 5, the waveform detection unit 101A detects pixel groups relevant to the plurality of waveforms in S14. In S14, the waveform detection unit 101A may detect a reference object (more precisely, a pixel group relevant to the reference object) drawn such that a predetermined numerical value represented in a predetermined unit has a predetermined size, such as the calibration waves W2 and W4 illustrated in FIG. 6.

In S15, the baseline derivation unit 105A derives a baseline serving as a reference for generating numerical data representing a time-series change of the biological signal in a predetermined unit relevant to the biological signal. For example, the baseline derivation unit 105A may detect a plurality of pixels at the position of the start point of the P wave from the pixels detected in S14, and derive a straight line connecting the pixels as a baseline (a baseline serving as a reference for generating numerical data in the y-axis direction). For example, the baseline derivation unit 105A may detect a pixel having the smallest x coordinate among the pixels detected in S14, and derive a straight line passing through the detected pixel and perpendicular to the x axis as a baseline (baseline serving as a reference for generating numerical data in the x-axis direction). In a case where a plurality of pixel groups have been detected in S14, the baseline derivation unit 105A derives a baseline for each pixel group (which can also be referred to as each waveform).

In S16, the scale specification unit 106A specifies the scale (both in the x-axis direction and the y-axis direction) in the image data generated in S13. For example, in a case where a reference object is detected in S14, the scale specification unit 106A may specify the scale from the detected size of the reference object. As described above, the grid drawn on the background of the waveform may be used as the reference object. In this case, the grid may be detected from the original image data from which the grid has not been removed, and the scale may be specified from the size (width) of the detected grid.

In a case where a plurality of pixel groups have been detected in S14, the scale specification unit 106A specifies the scale for each pixel group (which can also be referred to as each waveform). However, for a pixel group having a common scale, the scale may be specified only for any one of the pixel groups. For example, in a case where the scale in the x-axis direction is common to a plurality of pixel groups, the scale in the x-axis direction may be specified only for one pixel group, and the same scale may be applied to the other pixel groups.

In S17 (digitizing processing), based on the detection result in S14, the baseline derived in S15, and the scale specified in S16, the digitizing unit 102A generates numerical data representing the time-series change of the biological signal in a predetermined unit relevant to the biological signal. Specifically, for each of the x coordinate and the y coordinate of the pixel included in the pixel group relevant to one waveform, the digitizing unit 102A calculates a distance between the coordinate and the baseline, and multiplies the calculated distance by the scale specified in S16. By performing this processing for each pixel included in the pixel group, numerical data representing the time-series change of the biological signal is generated in a predetermined unit relevant to the biological signal. In a case where a plurality of pixel groups have been detected in S14, the digitizing unit 102A generates numerical data for each pixel group (which can also be referred to as each waveform). Accordingly, the process in FIG. 7 is ended.

### [Use of Generated Numerical Data]

The numerical data generated by the information processing device 1A can be used for various applications. For example, the information processing device 1A may include a function derivation unit that derives a function indicating a waveform of a biological signal by using numerical data generated from image data indicating the waveform. The value of the biological signal at any timing can be calculated by using the function indicating the waveform.

The generated numerical data can also be used for decision making in treatment or diagnosis, for example. From the viewpoint of use for treatment and diagnosis, for example, the information processing device 1A may include an index value calculation unit that calculates various index values used for diagnosis of the subject from numerical data generated from a biological signal of the subject. For example, in a case where the biological signal is an electrocardiogram, a width and a height of a P wave, a PQ interval (interval between the P wave and the Q wave), an RR interval (interval between vertices of two consecutive R waves on the electrocardiogram), a width of a QRS (from the start of the Q wave to the end of the S wave), and the like may be used as the index value.

For example, in a case where calculating the RR interval as the index value, the index value calculation unit may detect an extreme value satisfying a predetermined condition from the numerical data of the electrocardiogram, and estimate a position where the numerical data of the electrocardiogram becomes the extreme value as the position of the vertex of the R wave. As described above, the index value calculation unit can calculate various index values by simple calculation by using the numerical data generated by the digitizing unit 102A.

In a case where the index value calculation unit is provided, the information processing device 1A may further include a display control unit that displays the calculated index value together with image data indicating the waveform of the biological signal. As a result, it is possible to cause the medical worker to simultaneously recognize both the appearance characteristic and the index value of the waveform of the biological signal, and to assist rapid and highly accurate treatment and diagnosis.

For example, the information processing device 1A may include a diagnosis unit that determines the health condition or the presence or absence of a disease of the subject based on the calculated index value. In this case, the index value calculation unit may calculate an index value necessary for determination by the diagnosis unit. For example, in a case where the diagnosis unit determines the presence or absence of the arrhythmia, the index value calculation unit may calculate an index value necessary for the determination of the arrhythmia.

For example, the information processing device 1A may include a training data generation unit that generates training data used for machine learning of an inference model for inferring a state of the subject such as a health state or presence or absence of a disease of the subject from the biological signal of the subject using the generated numerical data. The training data generation unit may generate the training data using both the generated numerical data and the original image data. By using the training data generated in this manner, it is possible to generate an inference model capable of inference in consideration of both the feature as the numerical value of the biological data and the feature as the waveform. For example, the information processing device 1A may include a learning unit that generates the inference model by performing machine learning using the training data.

For example, in the flowchart of S7, after S17, the training data generation unit may perform the training data generation processing of generating training data. Furthermore, after the training data generation processing, the inference model generation processing of generating an inference model by the learning unit may be performed.

That is, the training data generation method according to the present illustrative example embodiment includes waveform detection processing of detecting a pixel group relevant to a portion of a waveform from image data indicating the waveform of a biological signal, digitizing processing of generating numerical data representing a time-series change of the biological signal in a predetermined unit relevant to the biological signal based on a detection result in the waveform detection processing, and training data generation processing of generating training data used for machine learning of an inference model for inferring a state of the subject from the numerical data of the biological signal of the subject using the generated numerical data. According to this training data generation method, it is possible to generate training data including numerical data of a biological signal as an explanatory variable by using image data indicating a waveform of the biological signal.

The inference model generation method according to the present illustrative example embodiment includes waveform detection processing of detecting a pixel group relevant to a portion of a waveform from image data indicating the waveform of the biological signal, digitizing processing of generating numerical data representing a time-series change of the biological signal in a predetermined unit relevant to the biological signal based on a detection result in the waveform detection processing, and inference model generation processing of generating an inference model for inferring a state of the subject from numerical data of the biological signal of the subject by machine learning using training data generated from the numerical data. According to this inference model generation method, it is possible to generate an inference model including numerical data of a biological signal as an explanatory variable by using image data indicating a waveform of the biological signal.

In general, numerical data has a smaller data amount than image data.

Therefore, if the numerical data generated by the information processing device 1A is stored instead of storing the image data of the waveform of the biological signal, the storage capacity of the biological signal data can be suppressed. In this case, the information processing device 1A may include an image generation unit that generates image data of a waveform of the biological signal from numerical data of the biological signal. As a result, it is possible to provide the image data of the waveform of the biological signal as necessary while suppressing the storage capacity of the biological signal data.

### Modified Examples

An executing entity of each processing described in the above-described illustrative example embodiments is optional, and is not limited to the above-described examples. For example, a system having functions similar to those of the information processing devices 1 and 1A can be constructed by a plurality of devices capable of communicating with each other. An execution subject of each processing and an execution subject of each processing of the above-described training data generation method and inference model generation method illustrated in the flowchart of FIG. 7 may be one device (also referred to as a processor) or a plurality of devices (also referred to as a processor).

### [Implementation Example by Software]

Some or all of the functions of the information processing devices 1 and 1A (hereinafter, also referred to as “each of the above devices”) may be implemented by hardware such as an integrated circuit (IC chip) or may be implemented by software.

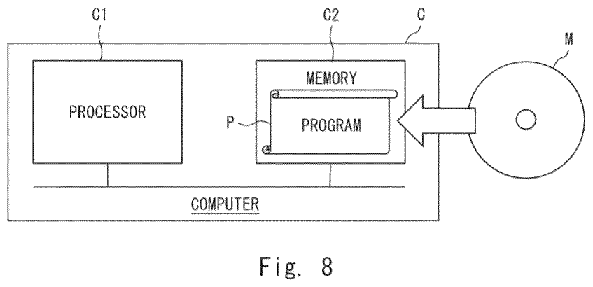

In the latter case, each of the above devices is implemented by, for example, a computer that executes commands of a program, that is software for implementing each function. An example of such a computer (hereinafter, referred to as a computer C) is illustrated in FIG. 8. FIG. 8 is a block diagram illustrating a hardware configuration of the computer C functioning as each of the above devices.

The computer C includes at least one processor C1 and at least one memory C2. A program (digitizing program) P for operating the computer C as each of the above devices is recorded in the memory C2. In the computer C, each function of each of the above devices is implemented by the processor C1 reading the program P from the memory C2 and executing the program P.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these can be used. As the memory C2, for example, a flash memory, a hard disk drive (HDD), a solid state drive (SSD), or a combination of these can be used.

The computer C may further include a random access memory (RAM) for loading the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above devices may be achieved by a single processor provided in a single computer, may be achieved in cooperation with a plurality of processors provided in a single computer, or may be achieved in cooperation with a plurality of processors provided in a plurality of computers. The program for causing each of the above devices to achieve each of the above functions may be stored in a single memory provided in a single computer, may be stored in a distributed manner in a plurality of memories provided in a single computer, or may be stored in a distributed manner in a plurality of memories provided in a plurality of computers.

### Supplementary Information

The present disclosure includes the techniques described in the following supplementary notes. However, the present invention is not limited to the technologies described in the following Supplementary Notes, and various modifications can be made within the scope described in the claims.

### Supplementary Note A1

An information processing device including: a waveform detection means for detecting, from image data indicating a waveform of a biological signal, a pixel group relevant to a portion of the waveform; and a digitizing means for generating numerical data representing a time-series change of the biological signal in a predetermined unit relevant to the biological signal based on a detection result of the waveform detection means.

### Supplementary Note A2

The information processing device according to Supplementary Note A1, including a detection means for detecting, from the image data, a reference object drawn in such a way that a predetermined numerical value represented in the predetermined unit has a predetermined size, in which the digitizing means generates numerical data representing a time-series change of the biological signal in the predetermined unit based on a size of the detected reference object.

### Supplementary Note A3

The information processing device according to Supplementary Note A1 or A2, including a baseline derivation means for deriving a baseline passing through a plurality of points at which the biological signal has a predetermined reference value in the waveform, in which the digitizing means generates numerical data representing a time-series change of the biological signal in the predetermined unit based on a distance from a pixel detected by the waveform detection means to the baseline.

### Supplementary Note A4

The information processing device according to any one of Supplementary Notes A1 to A3, including a preprocessing means for generating the image data by performing preprocessing of removing an element other than the waveform on original image data that is a source of the image data.

### Supplementary Note B1

A digitizing method for causing at least one processor to execute: waveform detection processing of detecting, from image data indicating a waveform of a biological signal, a pixel group relevant to a portion of the waveform; and digitizing processing of generating numerical data representing a time-series change of the biological signal in a predetermined unit relevant to the biological signal based on a detection result of the waveform detection processing.

### Supplementary Note B2

The digitizing method according to Supplementary Note B1, including detection processing of detecting, from the image data by the at least one processor, a reference object drawn in such a way that a predetermined numerical value represented in the predetermined unit has a predetermined size, in which in the digitizing processing, the at least one processor generates numerical data representing a time-series change of the biological signal in the predetermined unit based on a size of the detected reference object.

### Supplementary Note B3

The digitizing method according to Supplementary Note B1 or B2, including baseline derivation processing of deriving, by the at least one processor, a baseline passing through a plurality of points at which the biological signal has a predetermined reference value in the waveform, and in the digitizing processing, the at least one processor generates numerical data representing a time-series change of the biological signal in the predetermined unit based on a distance from a pixel detected in the waveform detection processing to the baseline.

### Supplementary Note B4

The digitizing method according to any one of Supplementary Notes B1 to B3, including preprocessing of generating, by the at least one processor, the image data by removing an element other than the waveform from original image data that is a source of the image data.

### Supplementary Note C1

A digitizing program for causing a computer to function as: a waveform detection means for detecting, from image data indicating a waveform of a biological signal, a pixel group relevant to a portion of the waveform; and a digitizing means for generating numerical data representing a time-series change of the biological signal in a predetermined unit relevant to the biological signal based on a detection result of the waveform detection means.

### Supplementary Note C2

The digitizing program according to Supplementary Note C1, in which the computer is caused to function as a detection means for detecting, from the image data, a reference object drawn in such a way that a predetermined numerical value represented in the predetermined unit has a predetermined size, and the digitizing means generates numerical data representing a time-series change of the biological signal in the predetermined unit based on a size of the detected reference object.

### Supplementary Note C3

The digitizing program according to Supplementary Note C1 or C2, in which the computer is caused to function as a baseline derivation means for deriving a baseline passing through a plurality of points at which the biological signal has a predetermined reference value in the waveform, and the digitizing means generates numerical data representing a time-series change of the biological signal in the predetermined unit based on a distance from a pixel detected by the waveform detection means to the baseline.

### Supplementary Note C4

The digitizing program according to any one of Supplementary Notes C1 to C3, in which the computer is caused to function as a preprocessing means for generating the image data by performing preprocessing of removing an element other than the waveform on original image data that is a source of the image data.

### Supplementary Note D1

An information processing device including at least one processor, in which the at least one processor executes: waveform detection processing of detecting, from image data indicating a waveform of a biological signal, a pixel group relevant to a portion of the waveform; and digitizing processing of generating numerical data representing a time-series change of the biological signal in a predetermined unit relevant to the biological signal based on a detection result of the waveform detection processing.

The information processing device may further include a memory. The memory may store a digitizing program for causing the at least one processor to execute each processing.

### Supplementary Note D2

The information processing device according to Supplementary Note D1, in which the at least one processor executes detection processing of detecting, from the image data by the at least one processor, a reference object drawn in such a way that a predetermined numerical value represented in the predetermined unit has a predetermined size, and in the digitizing processing, the at least one processor generates numerical data representing a time-series change of the biological signal in the predetermined unit based on a size of the detected reference object.

### Supplementary Note D3

The information processing device according to Supplementary Note D1 or D2, in which the at least one processor executes baseline derivation processing of deriving, by the at least one processor, a baseline passing through a plurality of points at which the biological signal has a predetermined reference value in the waveform, and in the digitizing processing, the at least one processor generates numerical data representing a time-series change of the biological signal in the predetermined unit based on a distance from a pixel detected in the waveform detection processing to the baseline.

### Supplementary Note D4

The information processing device according to any one of Supplementary Notes D1 to D3, in which the at least one processor executes preprocessing of generating, by the at least one processor, the image data by removing an element other than the waveform from original image data that is a source of the image data.

### Supplementary Note

A non-transitory recording medium having recorded therein a digitizing program for causing a computer to execute: waveform detection processing of detecting, from image data indicating a waveform of a biological signal, a pixel group relevant to a portion of the waveform; and digitizing processing of generating numerical data representing a time-series change of the biological signal in a predetermined unit relevant to the biological signal based on a detection result of the waveform detection processing.

1. An information processing device comprising:
a memory storing instructions; and
a processor configured to execute the instructions to:
assign coordinate values to pixels included in image data indicating a waveform of a biological signal;
detect, from the image data, pixel groups each including adjacent pixels;
select, as a first pixel group relevant to a portion of the waveform, a pixel group satisfying at least one of (i) a number of elements equal to or larger than a threshold and (ii) a distance from a left end pixel to a right end pixel equal to or more than a threshold;
detect, by pattern matching, a pixel group including a calibration wave;
exclude pixels of the pixel group including the calibration wave from the selected first pixel group; and
generate numerical data representing a time-series change of the biological signal in a predetermined unit relevant to the biological signal by converting coordinates of pixels in the first pixel group based on a scale for converting a pixel dimension to the predetermined unit.

2. The information processing device according to claim 1,
wherein the processor is further configured to execute the instructions to:
detect, from the image data, a second pixel group relevant to a reference object drawn in such a way that a predetermined numerical value represented in the predetermined unit has a predetermined size;
specify the scale for converting the pixel dimension to the predetermined unit based on a size of the detected second pixel group relevant to the reference object; and
generate the numerical data by converting the coordinates of the pixels in the first pixel group based on the specified scale.

3. The information processing device according to claim 1,
wherein the processor is further configured to execute the instructions to: derive a baseline passing through a plurality of points at which the biological signal has a predetermined reference value in the waveform; and
generate the numerical data representing the time-series change of the biological signal in the predetermined unit based on a distance from a pixel in the first pixel group to the baseline.

4. The information processing device according to claim 1
wherein the processor is further configured to execute the instructions to preprocess original image data that is a source of the image data, to generate the image data, the preprocessing including extracting, from the original image data, an area in which the waveform is drawn, binarizing the extracted area to remove a grid line of a background of the waveform, and performing mask processing on an area where information other than the waveform is displayed.

5. An inference model generation method for causing at least one processor to execute:
waveform detection processing of assigning coordinate values to pixels included in image data indicating the waveform of a biological signal, detecting pixel groups each including adjacent pixels from the image data, selecting, as a pixel group relevant to a portion of the waveform, a pixel group satisfying at least one of (i) a number of elements equal to or larger than a threshold and (ii) a distance from a left end pixel to a right end pixel equal to or more than a threshold, detecting, by pattern matching, a pixel group including a calibration wave, and excluding pixels of the pixel group including the calibration wave from the selected pixel group;
digitizing processing of generating numerical data representing a time-series change of the biological signal in a predetermined unit relevant to the biological signal by converting coordinates of pixels in the selected pixel group based on a scale for converting a pixel dimension to the predetermined unit; and
inference model generation processing of generating an inference model inferring a state of the subject from numerical data of a biological signal of the subject by machine learning using training data generated from the numerical data.

6. A digitizing method for causing at least one processor to execute:
waveform detection processing of assigning coordinate values to pixels included in image data indicating the waveform of a biological signal, detecting pixel groups each including adjacent pixels from the image data, selecting, as a pixel group relevant to a portion of the waveform, a pixel group satisfying at least one of (i) a number of elements equal to or larger than a threshold and (ii) a distance from a left end pixel to a right end pixel equal to or more than a threshold, detecting, by pattern matching, a pixel group including a calibration wave, and excluding pixels of the pixel group including the calibration wave from the selected pixel group; and
digitizing processing of generating numerical data representing a time-series change of the biological signal in a predetermined unit relevant to the biological signal by converting coordinates of pixels in the selected pixel group based on a scale for converting a pixel dimension to the predetermined unit.

7. A non-transitory computer-readable medium storing a digitizing program for causing a computer to function as:
a memory storing instructions; and
a processor configured to execute the instructions to:
assign coordinate values to pixels included in image data indicating a waveform of a biological signal;
detect, from the image data, pixel groups each including adjacent pixels;
select, as a pixel group relevant to a portion of the waveform, a pixel group satisfying at least one of (i) a number of elements equal to or larger than a threshold and (ii) a distance from a left end pixel to a right end pixel equal to or more than a threshold;
detect, by pattern matching, a pixel group including a calibration wave; exclude pixels of the pixel group including the calibration wave from the selected pixel group; and
generate numerical data representing a time-series change of the biological signal in a predetermined unit relevant to the biological signal by converting coordinates of pixels in the selected pixel group based on a scale for converting a pixel dimension to the predetermined unit.
